(19) United States
(12) Patent Application Publication
(10) Pub. No.: US 2016/0291981 A1
(43) Pub. Date: Oct. 6, 2016

(54) REMOVING INVALID LITERAL LOAD VALUES, AND RELATED CIRCUITS, METHODS, AND COMPUTER-READABLE MEDIA

(71) Applicant: QUALCOMM Incorporated, San Diego, CA (US)

(72) Inventors: Behnam Robatmili, San Jose, CA (US); Gheorghe Calin Cascaval, Palo Alto, CA (US); Michael William Morrow, Wilkes Barre, PA (US); Derek Jay Conrod, New York, NY (US); Bohuslav Rychlik, San Diego, CA (US)

(21) Appl. No.: 14/679,408

(22) Filed: Apr. 6, 2015

(51) Int. Cl. G06F 9/38

(52) U.S. Cl. CPC G06F 9/3857

(57) ABSTRACT

Removing invalid literal load values, and related circuits, methods, and computer-readable media are disclosed. In one aspect, an instruction processing circuit provides a literal load table containing one or more entries comprising an address and a cached literal load value. Upon detecting a literal load instruction in an instruction stream, the instruction processing circuit determines whether the literal load table contains an entry having an address of the literal load instruction. If so, the instruction processing circuit removes the literal load instruction from the instruction stream, and provides the cached literal load value stored in the entry to at least one dependent instruction. The instruction processing circuit further determines whether an invalidity indicator for the literal load table has been received. If so, the instruction processing circuit flushes the literal load table. The invalidity indicator may be generated responsive to modification of a constant table.

### BACKGROUND

I. Field of the Disclosure

The technology of the disclosure relates generally to literal load instructions provided by a computer processor.

II. Background

Computer programs executed by modern computer processors may frequently employ literal values. As used herein, a “literal value” is a value that is expressed as itself (e.g., a numeral “25” or a string “Hello World”) in a computer program's source code. Literal values may provide a convenient means for a computer program to represent and utilize values that do not change, or that change only rarely during execution of the computer program. Multiple literal values to be accessed during execution of the computer program may be stored together in memory as a block of data known as a “constant table” or “constant pool.”

A load instruction may be employed by a computer program to access a literal value located at a specified address (i.e., a “literal load value”), and to place the literal load value in a register for use by one or more subsequent dependent instructions following the load instruction in a processing pipeline. Such load instructions are referred to herein as “literal load instructions,” while the subsequent instructions that make use of the literal load value as an input are referred to as “dependent instructions.” In some computer architectures, a literal load instruction may specify the location of the literal load value in a constant pool as an address relative to an address of the literal load instruction itself. For example, the following instructions illustrate a literal load instruction and a subsequent dependent instruction that may be used by an ARM® architecture:

LDR R₀, [PC, #0x40]; retrieve a literal load value stored at program counter (PC)+0x40+8 into register R₀.

ADD R₁, R₀, R₀; use the literal load value by adding the value in register R₀ to itself, and storing the result in register R₁.

Due to data cache latency inherent in many conventional processors, a load instruction may incur a “load:use penalty” when loading a literal load value into a register. A load:use penalty refers to a minimum number of processor cycles that may elapse between dispatching of the load instruction and dispatching of a subsequent dependent instruction attributable to data cache latency. For instance, in the exemplary code above, the ADD instruction cannot be dispatched until the load:use penalty incurred by the LDR instruction has elapsed. Because the dependent instruction cannot be dispatched until the load instruction returns data, the load:use penalty may result in a “bubble” of underutilized processor cycles occurring within a processing pipeline.

The load:use penalty may be mitigated through the use of a literal load prediction mechanism, in which literal load values may be cached after a first execution of a literal load instruction and subsequently provided to dependent instructions pending the next execution of the literal load instruction. However, under such a literal load prediction mechanism, the dependent instructions cannot be retired until the literal load instruction has executed. Moreover, a literal load misprediction may require that all instructions following the literal load instruction be flushed and re-executed.

### SUMMARY OF THE DISCLOSURE

Aspects disclosed in the detailed description include removing invalid literal load values, and related circuits, methods, and computer-readable media. In some circumstances, all software operations that may result in a change to a literal value in a constant table may be known and detectable. By detecting such software operations, entries in a literal load table that are rendered invalid by the software operations may be identified and flushed, thus ensuring that the literal load table contents are always known to be valid. In this regard, in one aspect, an instruction processing circuit provides a literal load table for caching previously generated literal load values. The literal load table contains one or more entries, each comprising an address and a cached literal load value. Upon detecting a literal load instruction in an instruction stream that accesses a literal value in a constant table, the instruction processing circuit determines whether the literal load table contains an entry having an address corresponding to the literal load instruction. If so, it may be assumed that the literal load instruction has already executed at least once, and the resulting literal load value has been cached in the literal load table and is valid. Accordingly, the instruction processing circuit removes the literal load instruction from the instruction stream, and provides the cached literal load value stored in the entry to at least one dependent instruction of the literal load instruction. The instruction processing circuit further determines whether an invalidity indicator for the literal load table has been received. The invalidity indicator may be generated by, as a non-limiting example, a dynamic runtime capable of detecting all software operations that may result in modification of the literal value in the constant table corresponding to the entry in the literal load table. In response to determining that the invalidity indicator has been received, the instruction processing circuit may flush some or all of the entries in the literal load table. In this manner, processing performance may be improved by avoiding the additional overhead of literal load misprediction handling and unnecessary execution of literal load instructions, while enabling dependent instructions to access known valid literal load values without incurring a load:use penalty.

In another aspect, an instruction processing circuit is provided. The instruction processing circuit comprises a front-end circuit configured to fetch and decode instructions in an instruction stream, and a literal load table configured to provide one or more entries for caching literal load values. The instruction processing circuit is configured to detect, by the front-end circuit, a literal load instruction in the instruction stream that accesses a literal value of a constant table. The instruction processing circuit is further configured to determine whether an address of the literal load instruction is present in an entry of the literal load table. The instruction processing circuit is also configured to, responsive to determining that the address of the literal load instruction is present, remove the literal load instruction from the instruction stream. The instruction processing circuit is additionally configured to, responsive to determining that the address of the literal load instruction is present, provide a cached literal load value stored in the entry of the literal load table for execution of at least one dependent instruction of the literal load instruction. The instruction processing circuit is further configured to determine whether an invalidity indicator for the literal load table has been received. The instruction processing circuit is also configured to, responsive to receiving the invalidity indicator, flush the literal load table.

In another aspect, an instruction processing circuit is provided. The instruction processing circuit comprises a means for detecting, in an instruction stream, a literal load instruction that accesses a literal value of a constant table. The instruction processing circuit further comprises a means for determining whether an address of the literal load instruction is present in an entry of a literal load table. The instruction processing circuit also comprises a means for removing the literal load instruction from the instruction stream responsive to determining that the address of the literal load instruction is present. The instruction processing circuit additionally comprises a means for providing a cached literal load value stored in the entry of the literal load table for execution of at least one dependent instruction of the literal load instruction responsive to determining that the address of the literal load instruction is present. The instruction processing circuit further comprises a means for determining whether an invalidity indicator for the literal load table has been received. The instruction processing circuit also comprises a means for flushing the literal load table responsive to receiving the invalidity indicator.

In another aspect, a method for identifying invalid literal load values for removal from a literal load table is provided. The method comprises detecting, by a computer processor, an occurrence of a software operation. The method further comprises determining whether the software operation results in modification of a literal value in a constant table corresponding to an entry in a literal load table. The method also comprises, responsive to determining that the software operation results in the modification of the literal value, generating an invalidity indicator for the literal load table.

In another aspect, a non-transitory computer-readable medium is provided, having stored thereon computer-executable instructions which, when executed by a processor, cause the processor to detect an occurrence of a software operation. The computer-executable instructions further cause the processor to determine whether the software operation results in modification of a literal value in a constant table corresponding to an entry in a literal load table. The computer-executable instructions also cause the processor to, responsive to determining that the software operation results in the modification of the literal value, generate an invalidity indicator for the literal load table.

### BRIEF DESCRIPTION OF THE FIGURES

FIG. 1 is a block diagram of an exemplary computer processor including an instruction processing circuit for removing invalid literal load values;

FIGS. 2A-2C illustrate exemplary communications flows for establishing an entry in the literal load table of FIG. 1, providing a cached literal load value of the entry to a dependent instruction, and flushing the literal load table in response to receiving an invalidity indicator;

FIGS. 3A and 3B are flowcharts illustrating exemplary operations for removing invalid literal load values using the instruction processing circuit of FIG. 1;

FIG. 4 is a flowchart illustrating exemplary operations for determining whether an invalidity indicator is received in some aspects of the instruction processing circuit of FIG. 1;

FIG. 5 is a flowchart illustrating exemplary operations for generating an invalidity indicator based on detection of software operations that may modify cached values corresponding to cached literal load values in the literal load table of FIG. 1; and

FIG. 6 is a block diagram of an exemplary processor-based system that can include the instruction processing circuit of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include removing invalid literal load values, and related circuits, methods, and computer-readable media. In some circumstances, all software operations that may result in a change to a literal value in a constant table may be known and detectable. By detecting such software operations, entries in a literal load table that are rendered invalid by the software operations may be identified and flushed, thus ensuring that the literal load table contents are always known to be valid. In this regard, in one aspect, an instruction processing circuit provides a literal load table for caching previously generated literal load values. The literal load table contains one or more entries, each comprising an address and a cached literal load value. Upon detecting a literal load instruction in an instruction stream that accesses a literal value in a constant table, the instruction processing circuit determines whether the literal load table contains an entry having an address corresponding to the literal load instruction. If so, it may be assumed that the literal load instruction has already executed at least once, and the resulting literal load value has been cached in the literal load table and is valid. Accordingly, the instruction processing circuit removes the literal load instruction from the instruction stream, and provides the cached literal load value stored in the entry to at least one dependent instruction of the literal load instruction. The instruction processing circuit further determines whether an invalidity indicator for the literal load table has been received. The invalidity indicator may be generated by, as a non-limiting example, a dynamic runtime capable of detecting all software operations that may result in modification of the literal value in the constant table corresponding to the entry in the literal load table. In response to determining that the invalidity indicator has been received, the instruction processing circuit may flush some or all of the entries in the literal load table. In this manner, processing performance may be improved by avoiding the additional overhead of literal load misprediction handling and unnecessary execution of literal load instructions, while enabling dependent instructions to access known valid literal load values without incurring a load:use penalty.

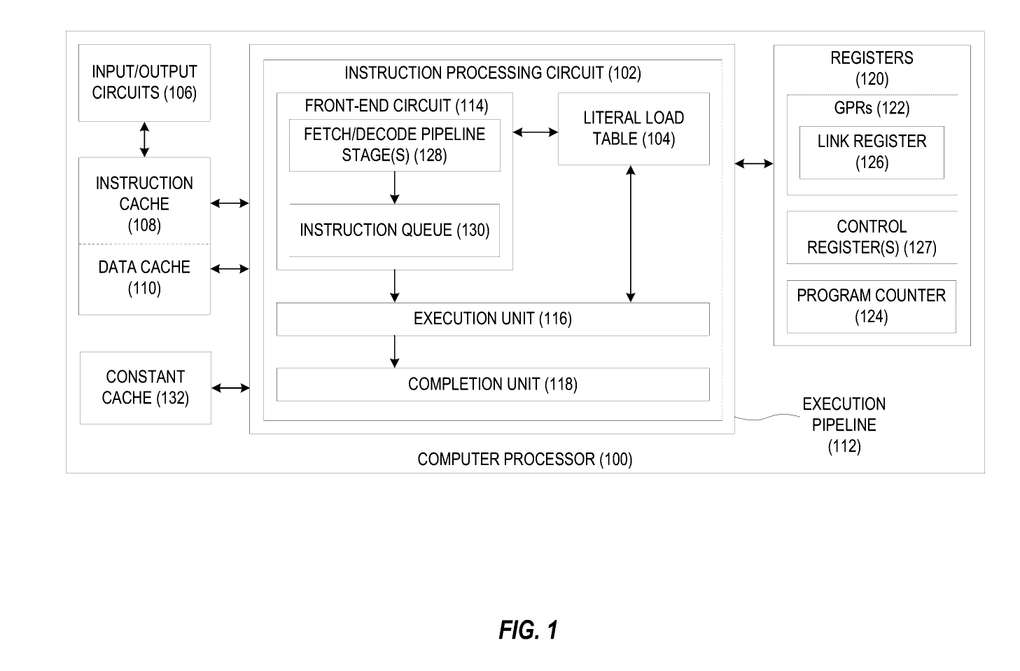

In this regard, FIG. 1 is a block diagram of an exemplary computer processor 100. The computer processor 100 includes an instruction processing circuit 102 providing a literal load table 104 for caching known valid literal load values and removing invalid literal load values, as disclosed herein. The computer processor 100 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages.

The computer processor 100 includes input/output circuits 106, an instruction cache 108, and a data cache 110. The computer processor 100 further comprises an execution pipeline 112, which includes a front-end circuit 114, an execution unit 116, and a completion unit 118. The computer processor 100 additionally includes registers 120, which comprise one or more general purpose registers (GPRs) 122, a program counter 124, and a link register 126. In some aspects, such as those employing the ARM® ARM7™ architecture, the link register 126 is one of the GPRs 122, as shown in FIG. 1. Alternately, some aspects, such as those utilizing the IBM® PowerPC® architecture, may provide that the link register 126 is separate from the GPRs 122 (not shown). In the example of FIG. 1, the registers 120 further include one or more control registers 127 for changing and/or controlling various aspects and features of the computer processor 100, as is known in the art.

In exemplary operation, the front-end circuit 114 of the execution pipeline 112 fetches instructions (not shown) from the instruction cache 108, which in some aspects may be an on-chip Level 1 (L1) cache, as a non-limiting example. The fetched instructions are decoded by the front-end circuit 114 and issued to the execution unit 116. The execution unit 116 executes the issued instructions, and the completion unit 118 retires the executed instructions. In some aspects, the completion unit 118 may comprise a write-back mechanism (not shown) that stores the execution results in one or more of the registers 120. It is to be understood that the execution unit 116 and/or the completion unit 118 may each comprise one or more sequential pipeline stages. In the example of FIG. 1, the front-end circuit 114 comprises one or more fetch/decode pipeline stages 128, which may enable multiple instructions to be fetched and decoded concurrently. An instruction queue 130 for holding the fetched instructions pending dispatch to the execution unit 116 is communicatively coupled to one or more of the fetch/decode pipeline stages 128.

The computer processor 100 of FIG. 1 further provides a constant cache 132 that is communicatively coupled to one or more elements of the execution pipeline 112. The constant cache 132 provides a quick-access mechanism by which a value previously stored in one of the registers 120 may be provided to an instruction that uses the value as an input operand. The constant cache 132 may thus improve the performance of the computer processor 100 by providing access to stored values more quickly than the registers 120.

While processing instructions in the execution pipeline 112, the instruction processing circuit 102 may fetch and execute a literal load instruction (not shown) for loading a literal load value into one of the registers 120. Processing the literal load instruction thus may include retrieving the literal load value from the data cache 110. However, in doing so, the literal load instruction may incur a load:use penalty resulting from an inherent latency in accessing the data cache 110. For example, in some computer architectures, accessing the data cache 110 may require two to three processor cycles to complete. Consequently, the instruction processing circuit 102 may be unable to dispatch a subsequent dependent instruction (not shown) until the load:use penalty incurred by the literal load instruction has elapsed. This may result in underutilization of the computer processor 100 within the execution pipeline 112.

In this regard, the instruction processing circuit 102 of FIG. 1 provides the literal load table 104 for minimizing load:use penalties and improving processor performance by caching literal load values upon execution of literal load instructions. When a subsequent occurrence of a literal load instruction is encountered, the instruction processing circuit 102 removes the literal load instruction (e.g., by preventing issuance of the literal load instruction), and may provide the cached literal load values to dependent instructions. The instruction processing circuit 102 also detects and removes invalid literal load values based on a received invalidity indicator (not shown). In some aspects, the invalidity indicator may be generated by software such as a dynamic runtime, which may detect software operations that result in modification of cached literal load values. Some aspects may provide that the software generating the invalidity indicator is capable of detecting all software operations that may modify cached literal load values, and of generating an invalidity indicator in response. In such aspects, the contents of the literal load table 104 provided by the instruction processing circuit 102 may be assumed to be always valid.

The front-end circuit 114 of the instruction processing circuit 102 is configured to detect literal load instructions (not shown) in an instruction stream (not shown) being processed within the execution pipeline 112. In some aspects, the instruction processing circuit 102 may be configured to detect literal load instructions based on an idiomatic form of a load instruction employed by the computer processor 100. As a non-limiting example, in a computer processor utilizing the ARM architecture, a literal load instruction may be detected by determining that the literal load instruction uses a program-counter-relative addressing mode, with the program counter offset specified by a constant.

As the literal load instruction is fetched by the front-end circuit 114 of the instruction processing circuit 102, the instruction processing circuit 102 may consult the literal load table 104. The literal load table 104 contains one or more entries (not shown), each of which may include an address of a previously detected literal load instruction, and a cached literal load value that was previously retrieved by the literal load instruction corresponding to the address. In some aspects, the address of the previously detected literal load instruction may comprise a program counter address and/or an individual or group cache tag, as non-limiting examples.

The instruction processing circuit 102 determines whether an address of the literal load instruction being fetched is present in an entry of the literal load table 104. If the address of the literal load instruction is found (i.e., a “hit”), the instruction processing circuit 102 removes the literal load instruction from the instruction stream. This is because, as noted above, the contents of the literal load table 104 contain only known valid literal values. Thus, there is no chance of misprediction of the results of executing the literal load instruction, and, consequently, no need to re-execute the literal load instruction. According to some aspects, the instruction processing circuit 102 may remove the literal load instruction from the instruction stream by preventing issuance of the literal load instruction.

The instruction processing circuit 102 may then provide the literal load value from the entry to at least one dependent instruction as a cached literal load value. In some aspects, the cached literal load value may be provided to the at least one dependent instruction via the constant cache 132. In this manner, the at least one dependent instruction may obtain the cached literal load value for the literal load instruction without incurring a corresponding load:use penalty.

As noted above, the instruction processing circuit 102 may identify and remove invalid entries in the literal load table 104 through the use of an invalidity indicator. In some aspects, the invalidity indicator may be generated by software such as a dynamic runtime, which may detect software operations that may result in modification of cached literal load values. The detected software operations may include, as non-limiting examples, a garbage collection operation and/or an inline cache address update operation. Based on the received invalidity indicator, the instruction processing circuit 102 may flush one or more of the entries of the literal load table 104 to ensure that no invalid literal values are provided to dependent instructions.

According to some aspects disclosed herein, if the instruction processing circuit 102 detects a literal load instruction but does not find the address of the literal load instruction in an entry of the literal load table 104, a “miss” occurs. In this case, the instruction processing circuit 102 may generate an entry in the literal load table 104 corresponding to the literal load instruction upon execution of the literal load instruction. The generated entry includes the address of the literal load instruction, and stores the actual literal load value loaded by the literal load instruction as the cached literal load value of the entry. Accordingly, if and when the literal load instruction is again detected by the instruction processing circuit 102, a “hit” in the literal load table 104 may occur, and the cached literal load value may be provided to a dependent instruction.

Some aspects of the instruction processing circuit 102 disclosed herein may employ one of the control registers 127 to set an operational mode of the instruction processing circuit 102. For instance, the literal load caching operations of the instruction processing circuit 102 may be selectively enabled or disabled by software using one of the control registers 127. In some aspects, the one or more of the control registers 127 may be used to place the instruction processing circuit 102 in a literal load value caching mode or a literal load value prediction mode. In the event of an event such as an interrupt, a context switch, and/or a parallel synchronization event, the instruction processing circuit 102 may store its operational mode as part of the architectural state of the computer processor 100.

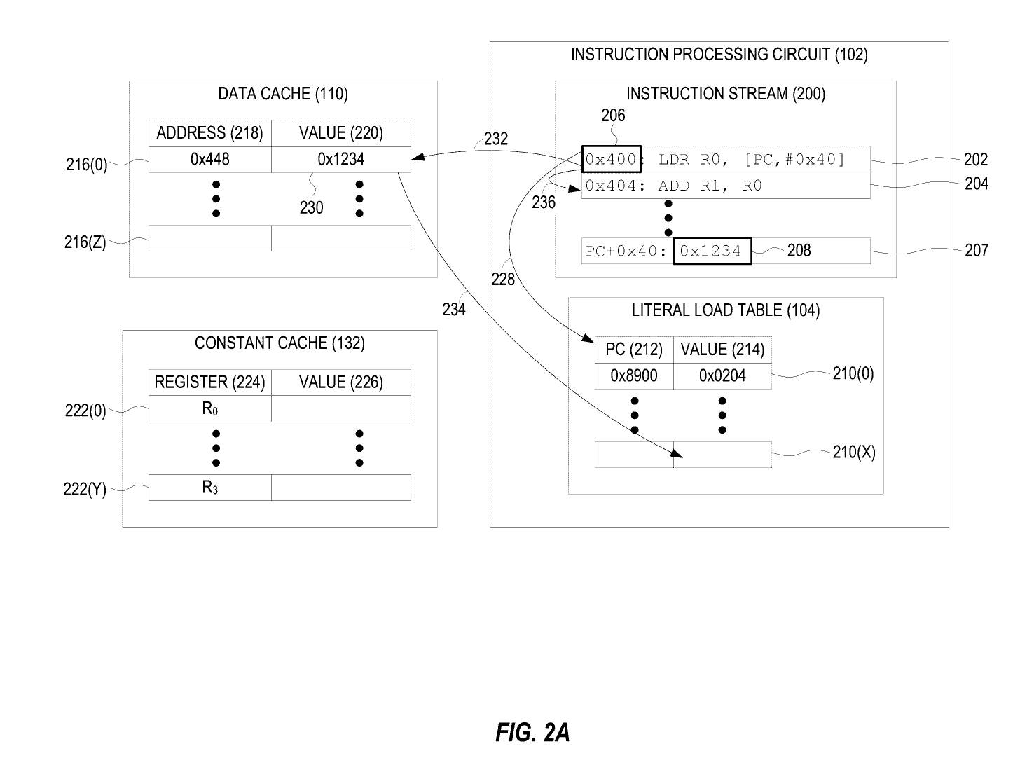

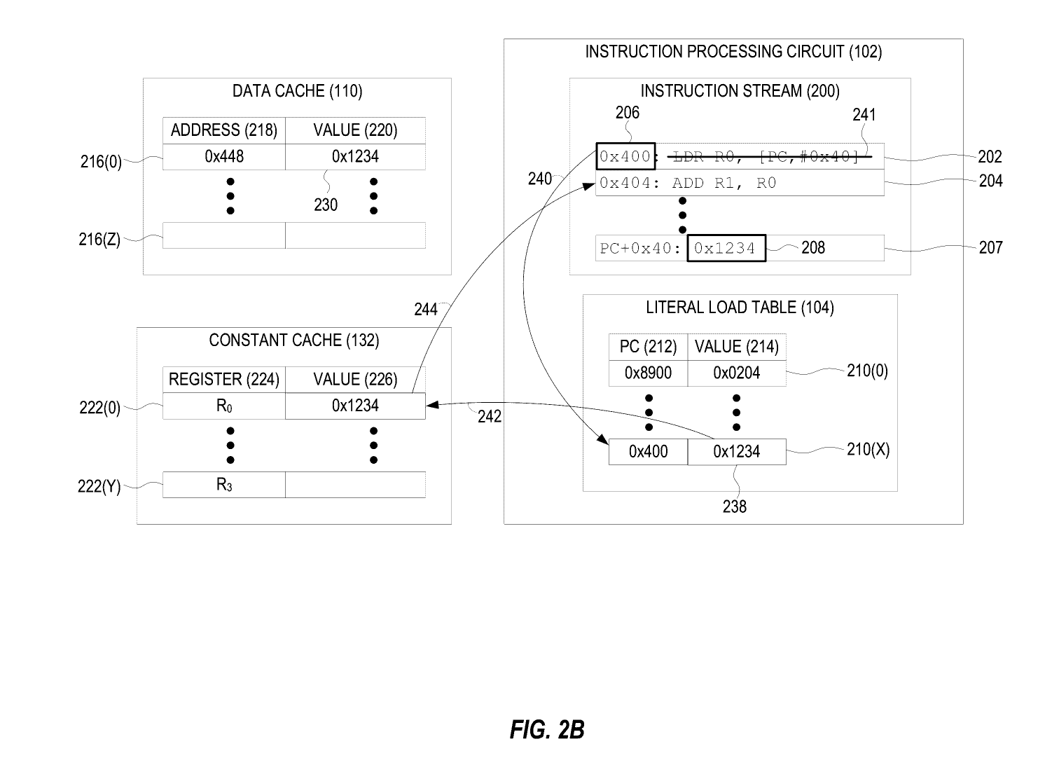

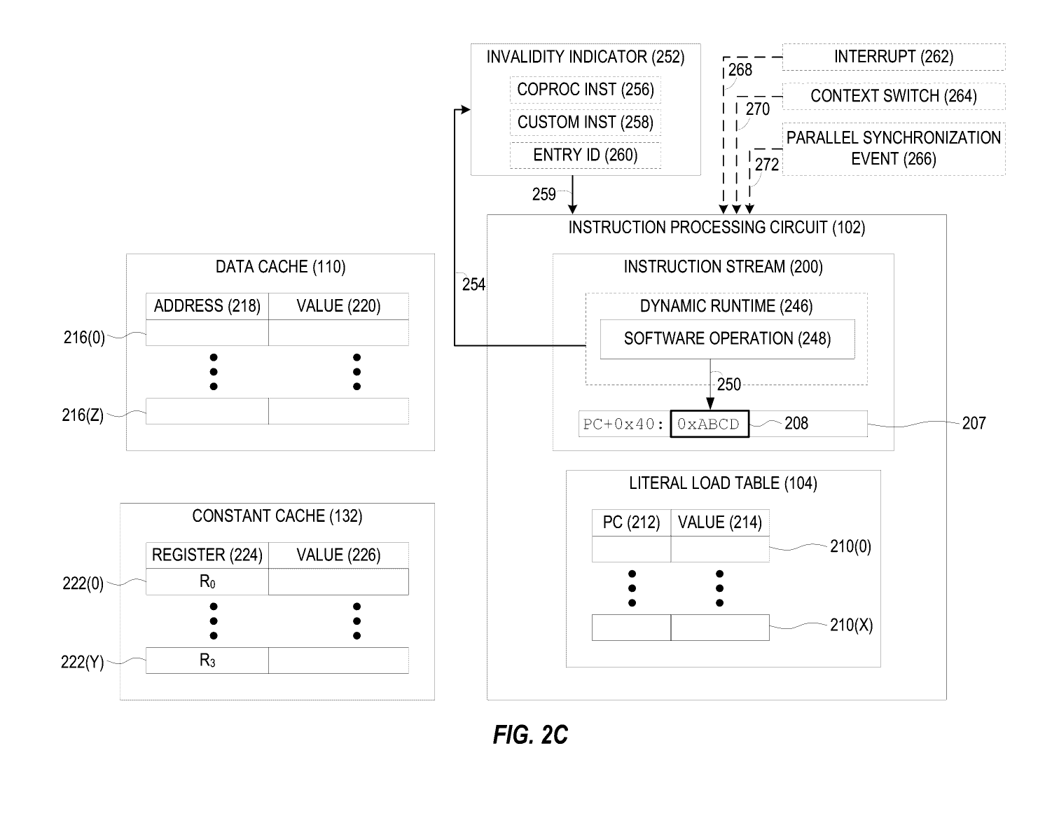

To better illustrate exemplary communications flows among the instruction processing circuit 102, the data cache 110, and the constant cache 132 of FIG. 1, FIGS. 2A-2C are provided. FIG. 2A illustrates exemplary communications flows for establishing an entry in the literal load table 104, while FIG. 2B shows exemplary communications flows for providing a cached literal load value of the entry to a dependent instruction. FIG. 2C illustrates exemplary communications flows for flushing invalid entries form the literal load table 104 in response to receiving an invalidity indicator.

In FIGS. 2A-2C, the instruction processing circuit 102 processes an instruction stream 200 comprising two instructions: a literal load instruction 202 and a dependent instruction 204. The literal load instruction 202 is associated with an address 206, which in this example is the hexadecimal value 0x400. It is to be understood that, in some aspects, the address 206 may be retrieved from, e.g., the program counter 124 of FIG. 1. It is to be further understood that, while the instruction stream 200 of FIGS. 2A-2C includes only one dependent instruction 204, in some aspects the dependent instruction 204 may comprise multiple dependent instructions.

The instruction stream 200 further includes a constant table 207 providing a literal value 208 for consumption by the literal load instruction 202. FIGS. 2A-2C show only a single constant table 207 and a single literal value 208 for the sake of clarity. However, it is to be understood that, according to some aspects, the instruction stream 200 may contain multiple constant tables 207 and/or multiple literal values 208. In some aspects, the constant table 207 may comprise an inline cache.

The literal load instruction 202 in this example is an LDR instruction, which directs the computer processor 100 to load a literal value from an address specified by a current value of the program counter 124 (PC) plus the hexadecimal value 0x40. In the example of FIGS. 2A-2C, the address corresponds to an address of the literal value 208 of the constant table 207. The literal value 208 is then stored in a register R₀, which may be one of the registers 120 of FIG. 1, as a non-limiting example. The dependent instruction 204 follows the literal load instruction 202 in the instruction stream 200, which in this example is an ADD instruction. The dependent instruction 204 receives the literal value 208 stored in the register R₀ as an input, and sums it with a value of a register R₁ (e.g., another one of the registers 120 of FIG. 1). The result is then stored in the register R₁.

The literal load table 104 illustrated in FIGS. 2A-2C includes multiple entries 210(0)-210(X). To facilitate caching of literal load values, each entry 210(0)-210(X) of the literal load table 104 includes a program counter (PC) field 212 and a value field 214. The program counter field 212 for each entry 210(0)-210(X) may be used to store the address 206 of the literal load instruction 202 that is detected by the instruction processing circuit 102. The value field 214 may store a cached literal load value based on the literal value 208 loaded by the literal load instruction 202 associated with the address 206 in the program counter field 212.

As seen in FIGS. 2A-2C, the data cache 110 is made up of entries 216(0)-216(Z), each comprising an address field 218 and a value field 220. Each of the entries 216(0)-216(Z) corresponds to a value retrieved during a previous execution of a load instruction. In this regard, the address field 218 stores an address of the previously retrieved value, while the value field 220 stores a copy of the value.

The constant cache 132 shown in FIGS. 2A-2C comprises entries 222(0)-222(Y). Each of the entries 222(0)-222(Y) includes a register field 224 and a value field 226. The register field 224 of each entry 222(0)-222(Y) indicates one of the registers 120 of FIG. 1 associated with the entry 222(0)-222(Y), while the value field 226 indicates a value most recently stored in the corresponding register 120. As discussed above, the constant cache 132 may provide a quick-access mechanism providing speedier access to cached values than loading the values directly from the registers 120.

Referring now to FIG. 2A, communications flows in some aspects for establishing an entry 210(X) in the literal load table 104 are illustrated. As the instruction processing circuit 102 processes the instruction stream 200 for the first time, a first instance of the literal load instruction 202 is detected. As indicated by arrow 228, the instruction processing circuit 102 checks the literal load table 104 to determine whether the address 206 of the literal load instruction 202 (i.e., the hexadecimal value 0x400) may be found in any of the entries 210(0)-210(X). The instruction processing circuit 102 does not find the address 206 in the entries 210(0)-210(X), and thus, in response to the “miss,” continues conventional processing of the literal load instruction 202.

Upon execution of the literal load instruction 202, the entry 216(0) of the data cache 110 is populated with an actual literal load value 230 loaded by the literal load instruction 202 (here, the hexadecimal value 0x1234). As indicated by arrow 232, the instruction processing circuit 102 accesses the entry 216(0) of the data cache 110, and obtains the actual literal load value 230. The instruction processing circuit 102 next generates the entry 210(X) in the literal load table 104 based on the actual literal load value 230, as indicated by arrow 234. The address 206 of the literal load instruction 202 will be stored in the program counter field 212 of the entry 210(X), while the actual literal load value 230 will be stored as a cached literal load value in the value field 214 of the entry 210(X). The actual literal load value 230 loaded into register R₀ by the literal load instruction 202 is then forwarded to the dependent instruction 204 using conventional mechanisms, as indicated by arrow 236.

FIG. 2B illustrates the use of the entry 210(X) of the literal load table 104 for removing a subsequent instance of the literal load instruction 202 from the instruction stream 200, and for providing a cached literal load value 238 to the dependent instruction 204. As seen in FIG. 2B, the address 206 of the literal load instruction 202 is stored in the program counter field 212 of the entry 210(X), while the actual literal load value 230 of FIG. 2A is stored as the cached literal load value 238 in the value field 214 of the entry 210(X). The instruction processing circuit 102 processes the instruction stream 200 again, and detects a second instance of the literal load instruction 202. As indicated by arrow 240, the instruction processing circuit 102 checks the literal load table 104 to determine whether the address 206 is found in any of the entries 210(0)-210(X), and this time locates the entry 210(X).

Because the contents of the literal load table 104 are known to be valid, there is no need to re-execute the literal load instruction 202 after the entry 210(X) is located. Accordingly, the instruction processing circuit 102 removes the literal load instruction 202 from the instruction stream 200, as indicated by strikethrough 241. In some aspects, the instruction processing circuit 102 may remove the literal load instruction 202 by preventing issuance of the literal load instruction 202. The instruction processing circuit 102 then assigns the cached literal load value 238 provided by the entry 210(X) to the entry 222(0) in the constant cache 132 corresponding to register R₀, as indicated by arrow 242. The cached literal load value 238 is then provided to the dependent instruction 204 via the constant cache 132, as indicated by arrow 244. In this manner, the dependent instruction 204 is able to receive the cached literal load value 238 while incurring no load:use penalty.

To illustrate removal of invalid literal load values from the literal load table 104, FIG. 2C is provided. In the example of FIG. 2C, a dynamic runtime 246 is executed by the instruction processing circuit 102, and detects a software operation 248 that has or will modify the literal value 208 in the constant table 207 corresponding to the entry 210(X) in the literal load table 104, as indicated by arrow 250. According to some aspects, the software operation 248 may comprise a garbage collection operation and/or an inline cache address update operation, as non-limiting examples. As a result of the software operation 248, the entry 210(X) will be rendered invalid because the cached literal value 238 of FIG. 2B will no longer correspond to the literal value 208 in the constant table 207. Thus, an invalidity indicator 252 is generated to notify the instruction processing circuit 102 that the entry 210(X) is invalid, as indicated by arrow 254. In some aspects, the invalidity indicator 252 may be generated by setting a control register 127 of the computer processor 100 (shown in FIG. 1). Some aspects may provide that generating the invalidity indicator 252 comprises performing a coprocessor instruction invocation (COPROC INST) 256 or a custom architectural instruction invocation (CUSTOM INST) 258. In the former case, a coprocessor instruction provided by the computer architecture of the computer processor 100 may be adapted for use as a mechanism for providing the invalidity indicator 252 and invoked by the dynamic runtime 246. In the latter case, the computer architecture may define custom instructions for providing the invalidity indicator 252 that may be invoked by the dynamic runtime 246.

In response to receiving the invalidity indicator 252, as indicated by arrow 259, the instruction processing circuit 102 flushes the literal load table 104. In the example of FIG. 2C, the instruction processing circuit 102 has flushed all of the entries 210(0)-210(X) of the literal load table 104 (as well as the entries 216, 222 of the data cache 110 and the constant cache 132, respectively). While this approach guarantees that no invalid entries 210(0)-210(X) remain in the literal load table 104, the instruction processing circuit 102 may take longer to repopulate the literal load table 104. Some aspects of the instruction processing circuit 102 may provide selective flushing of the literal load table 104. In such aspects, the invalidity indicator 252 may include an identification (ENTRY ID) 260 identifying one or more of the entries 210(0)-210(X). The identification 260 may comprise, for example, an instruction address and/or a literal value corresponding to the program counter field 212 and/or the value field 214, respectively, of one of the entries 210(0)-210(X). Based on the identification 260, the instruction processing circuit 102 may selectively flush only a subset or a single one of the entries 210(0)-210(X). This may result in improved performance, as other valid entries 210(0)-210(X) may remain cached in the literal load table 104.

According to some aspects, the instruction processing circuit 102 may be configured to flush the literal load table 104 in response to other detected events besides receiving the invalidity indicator 252. In the example of FIG. 2C, the instruction processing circuit 102 may be configured to flush the literal load table 104 in response to an interrupt 262, a context switch 264, and/or a parallel synchronization event 266, as indicated by arrows 268, 270, and 272, respectively.

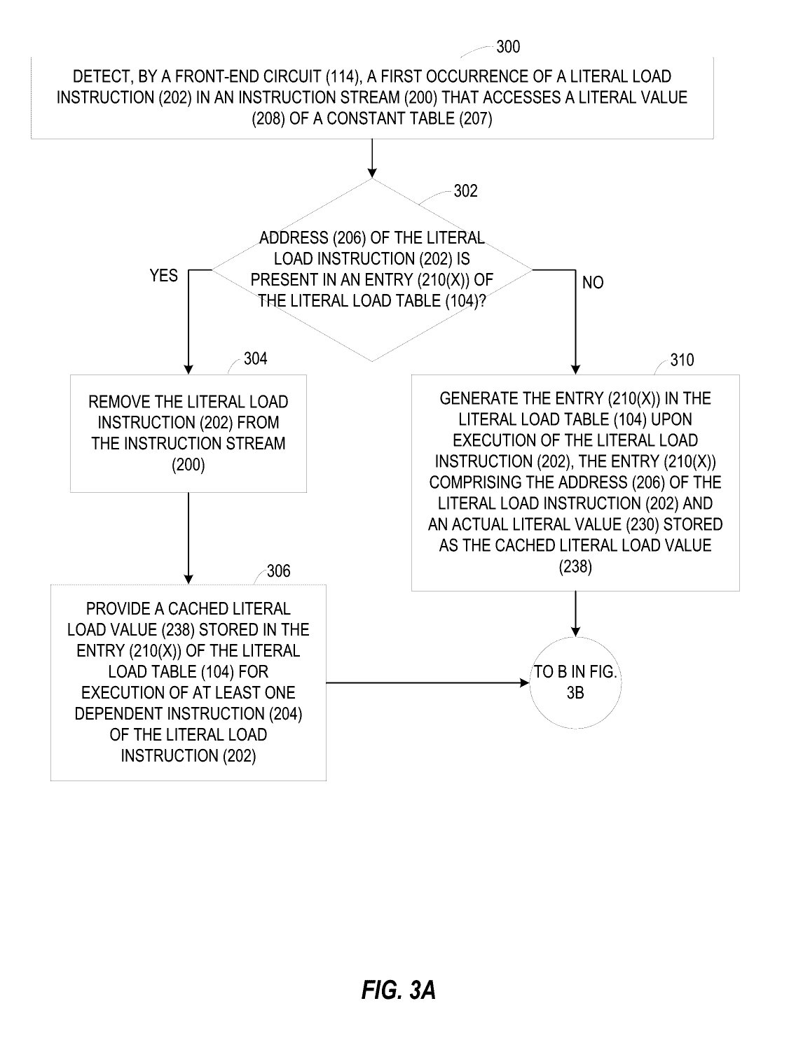

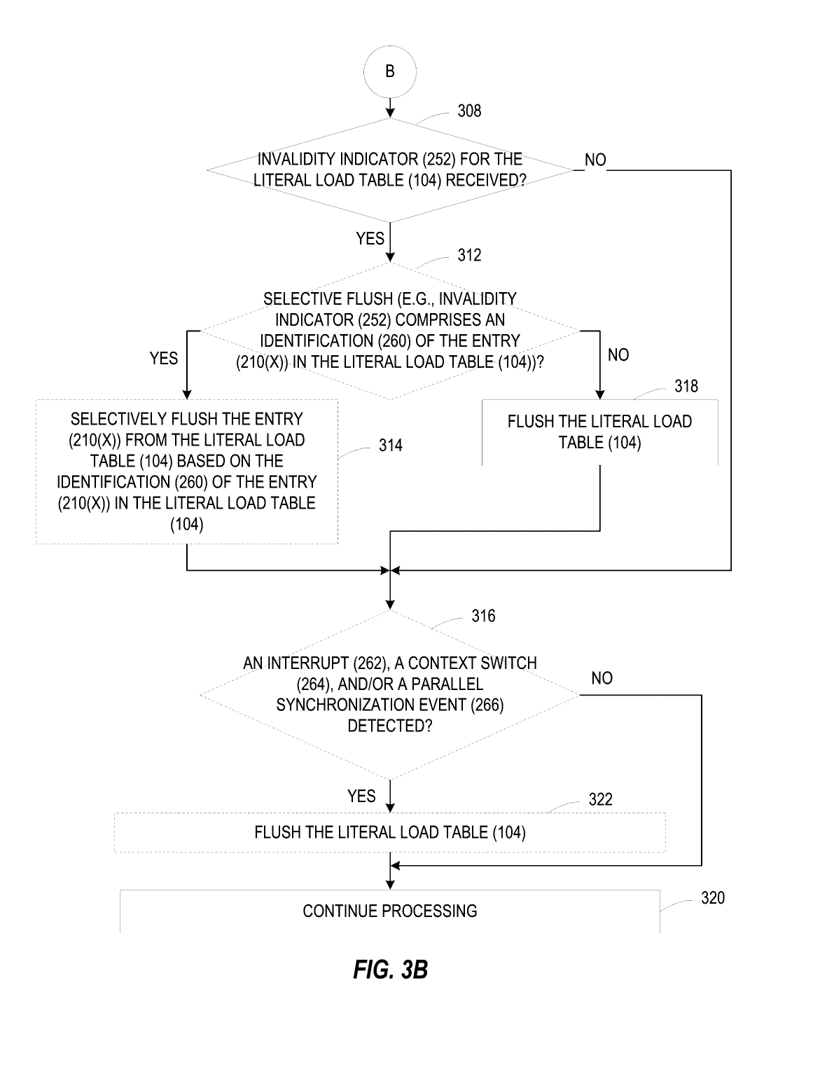

FIGS. 3A and 3B are flowcharts illustrating exemplary operations of the instruction processing circuit 102 of FIG. 1 for removing invalid literal load values. In particular, FIG. 3A illustrates exemplary operations carried out in response to detecting the literal load instruction 202 in the instruction stream 200 of FIGS. 2A-2C. FIG. 3B illustrates exemplary operations for removing invalid entries 210 from the literal load table 104 upon receipt of the invalidity indicator 252 of FIG. 2C. For the sake of clarity, elements of FIGS. 1 and 2A-2C are referenced in describing FIGS. 3A and 3B.

In FIG. 3A, operations begin with the instruction processing circuit 102 of FIG. 1 detecting, by the front-end circuit 114, the literal load instruction 202 in the instruction stream 200 that accesses the literal value 208 of the constant table 207 (block 300). Detecting the literal load instruction 202 may be accomplished by, for example, recognizing an idiomatic form of a load instruction in the instruction stream 200. The instruction processing circuit 102 next determines whether the address 206 of the literal load instruction 202 is present in an entry 210(X) of the literal load table 104 (block 302). If so, the instruction processing circuit 102 removes the literal load instruction 202 from the instruction stream 200, thus avoiding unnecessary execution of the literal load instruction 202 (block 304). In some aspects, removing the literal load instruction 202 may comprise preventing issuance of the literal load instruction 202. The instruction processing circuit 102 then provides a cached literal load value 238 stored in the entry 210(X) of the literal load table 104 for execution of at least one dependent instruction 204 of the literal load instruction 202 (block 306). The dependent instruction 204 thus may receive the cached literal load value 238 without incurring a load:use penalty. Processing then resumes at block 308 of FIG. 3B.

If, at decision block 302, the instruction processing circuit 102 determines that the address 206 of the literal load instruction 202 is not present in an entry 210(X) of the literal load table 104, the instruction processing circuit 102 generates the entry 210(X) in the literal load table 104 upon execution of the literal load instruction 202 (block 310). The entry 210(X) includes the address 206 of the literal load instruction 202, and contains an actual literal load value 230 stored as the cached literal load value 238. Processing then resumes at block 308 of FIG. 3B.

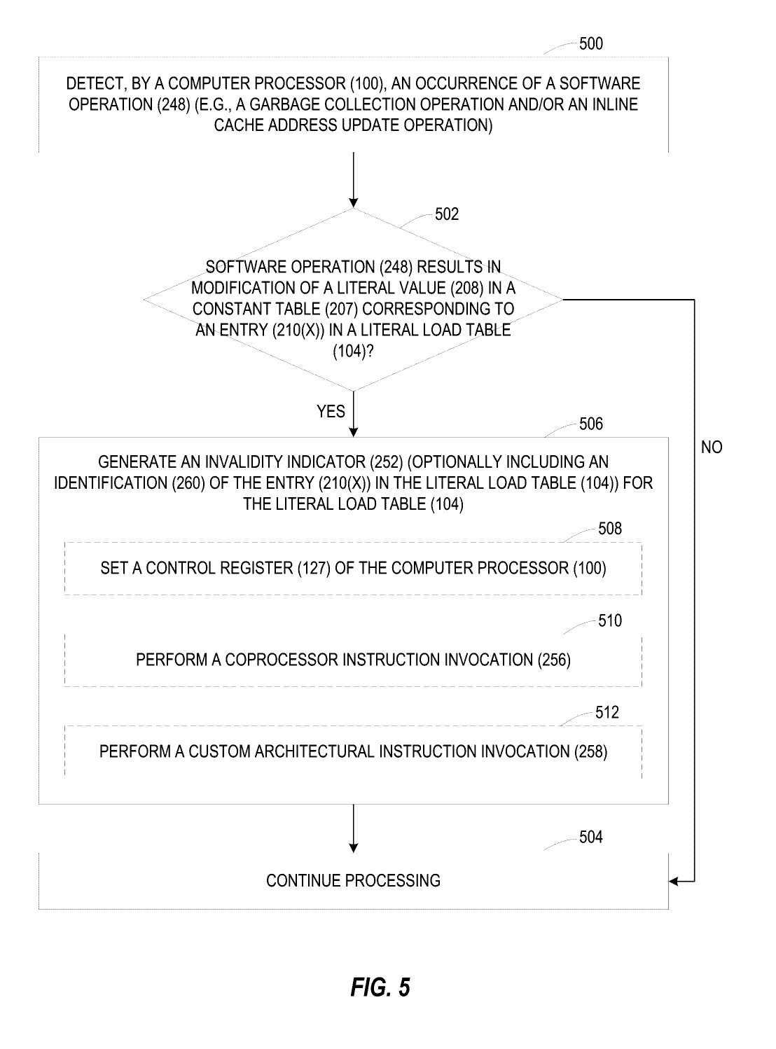

Referring now to FIG. 3B, the instruction processing circuit 102 determines whether the invalidity indicator 252 for the literal load table 104 has been received (block 308). Operations for generating the invalidity indicator 252 are discussed below in greater detail with respect to FIG. 5. If the instruction processing circuit 102 determines at decision block 308 that the invalidity indicator 252 was received, the instruction processing circuit 102 in some aspects may optionally determine whether the invalidity indicator 252 indicates a selective flush (block 312). As a non-limiting example, the invalidity indicator 252 may comprise an identification 260 of the entry 210(X) in the literal load table 104 for selective flushing. If a selective flush is indicated, the instruction processing circuit 102 may selectively flush the entry 210(X) from the literal load table 104 based on the identification 260 of the entry 210(X) in the literal load table 104 (block 314). Processing then resumes at block 316. However, if the instruction processing circuit 102 determines at decision block 312 that a selective flush is not indicated (or if this optional operation is omitted), the instruction processing circuit 102 flushes the literal load table 104 (i.e., flushes all entries 210(0)-210(X) within the literal load table 104) (block 318).

According to some aspects, the instruction processing circuit 102 may next determine whether an interrupt 262, a context switch 264, and/or a parallel synchronization event 266 has been detected (block 316). Any one of the aforementioned events may result in invalidation of the contents of the literal load table 104. If no such event has been detected, processing continues at block 320. However, if the instruction processing circuit 102 determines at decision block 316 that an interrupt 262, a context switch 264, and/or a parallel synchronization event 266 has been detected, the instruction processing circuit 102 flushes the literal load table 104 (block 322). In some aspects, in the event of an interrupt 262, a context switch 264, and/or a parallel synchronization event 266, the instruction processing circuit 102 may store an operational mode of the instruction processing circuit 102 as part of the architectural state of the computer processor 100.

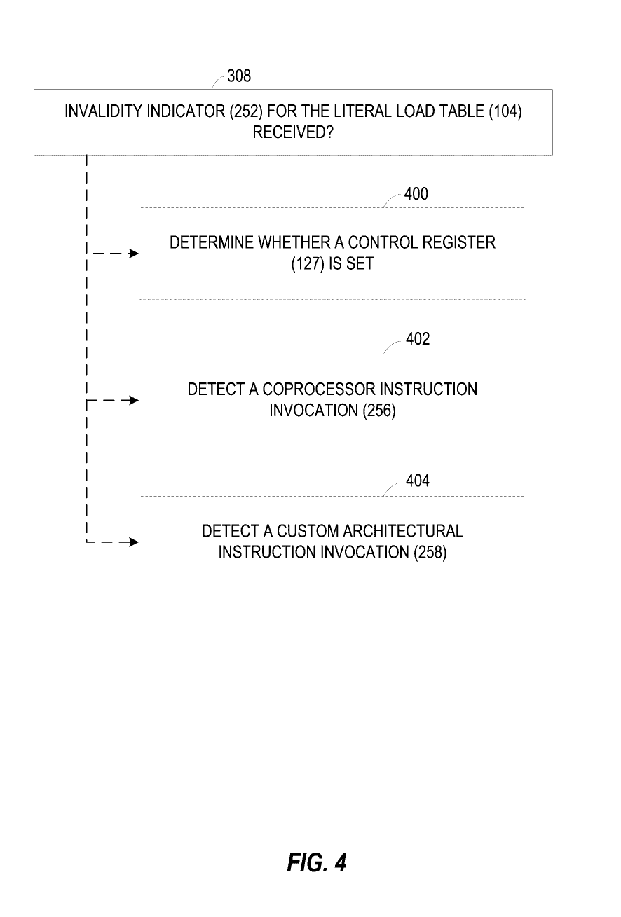

To illustrate exemplary operations for receiving the invalidity indicator 252 of FIG. 2C by the instruction processing circuit 102 of FIG. 1, FIG. 4 is provided. Elements of FIGS. 1 and 2A-2C are referenced in describing FIG. 4 for the sake of clarity. As seen in FIG. 3B, the instruction processing circuit 102 may determine whether the invalidity indicator 252 for the literal load table 104 has been received (block 308 from FIG. 3B). In FIG. 4, some aspects of the instruction processing circuit 102 may determine whether the invalidity indicator 252 has been received by determining whether a control register 127 is set (block 400). According to some aspects of the instruction processing circuit 102, determining whether the invalidity indicator 252 has been received may comprise detecting a coprocessor instruction invocation 256 (block 402). In some aspects, the instruction processing circuit 102 may determine whether the invalidity indicator 252 has been received by detecting a custom architectural instruction invocation 258 (block 404).

As discussed above, the invalidity indicator 252 of FIG. 2C may be generated by software such as a dynamic runtime 246 that may guarantee that changes to the constant table 207 are detected. In this regard, FIG. 5 illustrates exemplary operations for generating the invalidity indicator 252. For the sake of clarity, elements of FIGS. 1 and 2A-2C are referenced in describing FIG. 5. In FIG. 5, operations begin with the computer processor 100 of FIG. 1 detecting an occurrence of a software operation 248 (block 500). In some aspects, the software operation 248 may comprise a garbage collection operation and/or an inline cache address update operation, as non-limiting examples. The computer processor 100 then determines whether the software operation 248 results in modification of the literal value 208 in the constant table 207 corresponding to the entry 210(X) in the literal load table 104 (block 502). If so, the entry 210(X) in the literal load table 104 will be rendered invalid, because the literal value 208 in the constant table 207 no longer matches the cached literal load value 238. If the software operation 248 does not affect the literal value 208 in the constant table 207, processing resumes at block 504.

However, if it is determined at decision block 502 that the software operation 248 results in modification of the literal value 208, the invalidity indicator 252 is generated for the literal load table 104 (block 506). In some aspects, the invalidity indicator 252 may include an identification 260 of the entry 210(X) in the literal load table 104 to enable selective flushing of the entry 210(X). Depending on the implementation of the instruction processing circuit 102 of FIG. 1, operations for generating the invalidity indicator 252 may vary. In some aspects, the computer processor 100 may set a control register 127 of the computer processor 100 (block 508). Some aspects may provide that the computer processor 100 generates the invalidity indicator 252 by performing a coprocessor instruction invocation 256 (block 510). According to some aspects, the computer processor 100 may generate the invalidity indicator 252 by performing a custom architectural instruction invocation 258 (block 512). After generating the invalidity indicator 252, processing resumes at block 504.

Removing invalid literal load values according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

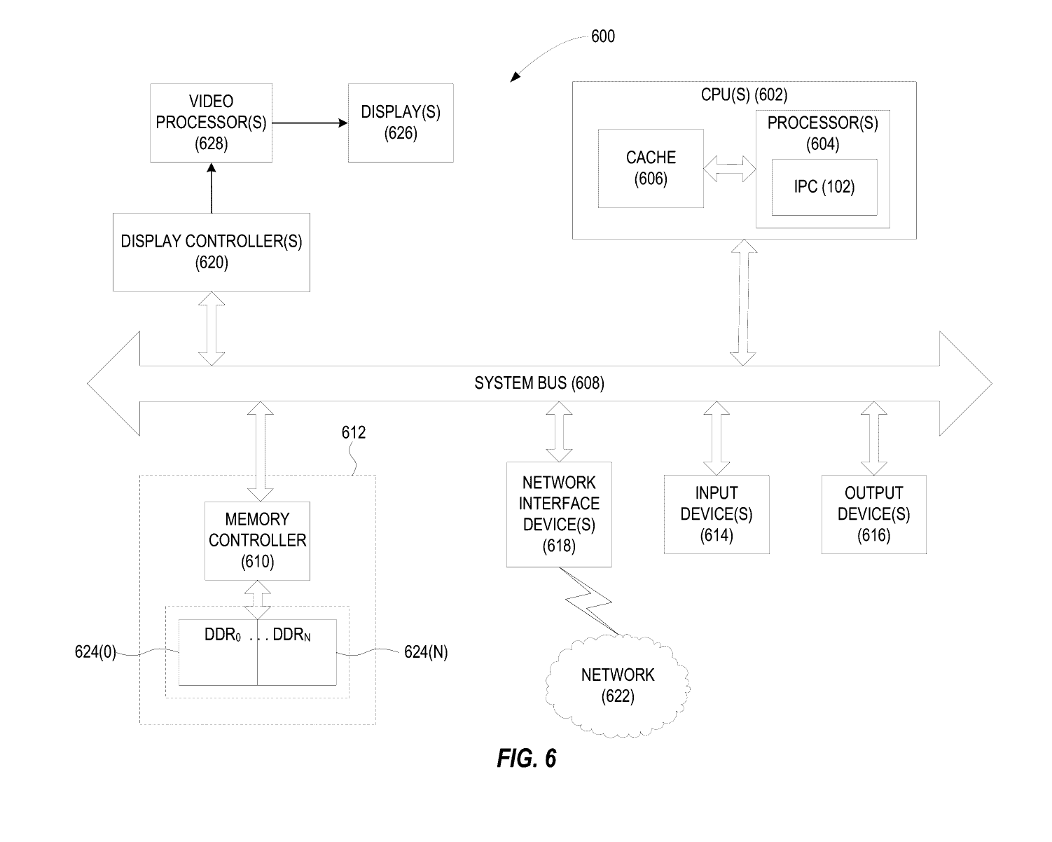

In this regard, FIG. 6 illustrates an example of a processor-based system 600 that can employ the instruction processing circuit 102 illustrated in FIGS. 1 and 2A-2C. In this example, the processor-based system 600 includes one or more central processing units (CPUs) 602, each including one or more processors 604. The one or more processors 604 may include the instruction processing circuit (IPC) 102 of FIGS. 1 and 2A-2C. The CPU(s) 602 may be a master device. The CPU(s) 602 may have cache memory 606 coupled to the processor(s) 604 for rapid access to temporarily stored data. The CPU(s) 602 is coupled to a system bus 608 and can intercouple master and slave devices included in the processor-based system 600. As is well known, the CPU(s) 602 communicates with these other devices by exchanging address, control, and data information over the system bus 608. For example, the CPU(s) 602 can communicate bus transaction requests to a memory controller 610 as an example of a slave device.

Other master and slave devices can be connected to the system bus 608. As illustrated in FIG. 6, these devices can include a memory system 612, one or more input devices 614, one or more output devices 616, one or more network interface devices 618, and one or more display controllers 620, as examples. The input device(s) 614 can include any type of input device, including but not limited to input keys, switches, voice processors, etc. The output device(s) 616 can include any type of output device, including but not limited to audio, video, other visual indicators, etc. The network interface device(s) 618 can be any devices configured to allow exchange of data to and from a network 622. The network 622 can be any type of network, including but not limited to a wired or wireless network, a private or public network, a local area network (LAN), a wide local area network (WLAN), and the Internet. The network interface device(s) 618 can be configured to support any type of communications protocol desired. The memory system 612 can include one or more memory units 624(0-N).

The CPU(s) 602 may also be configured to access the display controller(s) 620 over the system bus 608 to control information sent to one or more displays 626. The display controller(s) 620 sends information to the display(s) 626 to be displayed via one or more video processors 628, which process the information to be displayed into a format suitable for the display(s) 626. The display(s) 626 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. An instruction processing circuit, comprising:
a front-end circuit configured to fetch and decode instructions in an instruction stream; and
a literal load table configured to provide one or more entries for caching literal load values;
the instruction processing circuit configured to:
detect, by the front-end circuit, a literal load instruction in the instruction stream that accesses a literal value of a constant table;
determine whether an address of the literal load instruction is present in an entry of the literal load table;
responsive to determining that the address of the literal load instruction is present:
remove the literal load instruction from the instruction stream; and
provide a cached literal load value stored in the entry of the literal load table for execution of at least one dependent instruction of the literal load instruction;
determine whether an invalidity indicator for the literal load table has been received; and
responsive to receiving the invalidity indicator, flush the literal load table.

2. The instruction processing circuit of claim 1, further configured to:
responsive to determining that the address of the literal load instruction is not present in the entry of the literal load table, generate the entry in the literal load table upon execution of the literal load instruction, the entry comprising the address of the literal load instruction and an actual literal load value stored as the cached literal load value.

3. The instruction processing circuit of claim 1, configured to:
determine whether the invalidity indicator for the literal load table has been received by determining whether the invalidity indicator comprising an identification of the entry in the literal load table has been received; and
flush the literal load table by selectively flushing the entry from the literal load table based on the identification of the entry in the literal load table.

4. The instruction processing circuit of claim 1, configured to determine whether the invalidity indicator for the literal load table has been received by determining whether a control register is set.

5. The instruction processing circuit of claim 1, configured to determine whether the invalidity indicator for the literal load table has been received by detecting a coprocessor instruction invocation.

6. The instruction processing circuit of claim 1, configured to determine whether the invalidity indicator for the literal load table has been received by detecting a custom architectural instruction invocation.

7. The instruction processing circuit of claim 1, further configured to:
detect one of an interrupt, a context switch, and a parallel synchronization event; and
responsive to the detecting, flush the literal load table.

8. The instruction processing circuit of claim 1 integrated into an integrated circuit (IC).

9. The instruction processing circuit of claim 1 integrated into a device selected from the group consisting of: a set top box; an entertainment unit; a navigation device; a communications device; a fixed location data unit; a mobile location data unit; a mobile phone; a cellular phone; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; and a portable digital video player.

10. An instruction processing circuit, comprising:
a means for detecting, in an instruction stream, a literal load instruction that accesses a literal value of a constant table;
a means for determining whether an address of the literal load instruction is present in an entry of a literal load table;
a means for removing the literal load instruction from the instruction stream responsive to determining that the address of the literal load instruction is present;
a means for providing a cached literal load value stored in the entry of the literal load table for execution of at least one dependent instruction of the literal load instruction responsive to determining that the address of the literal load instruction is present;
a means for determining whether an invalidity indicator for the literal load table has been received; and
a means for flushing the literal load table responsive to receiving the invalidity indicator.

11. The instruction processing circuit of claim 10, further comprising a means for generating the entry in the literal load table upon execution of the literal load instruction, the entry comprising the address of the literal load instruction and an actual literal load value stored as the cached literal load value, responsive to determining that the address of the literal load instruction is not present in the entry of the literal load table.

12. The instruction processing circuit of claim 10, wherein:
the means for determining whether the invalidity indicator for the literal load table has been received comprises a means for determining whether the invalidity indicator comprising an identification of the entry in the literal load table has been received; and
the means for flushing the literal load table comprises a means for selectively flushing the entry from the literal load table based on the identification of the entry in the literal load table.

13. The instruction processing circuit of claim 10, wherein the means for determining whether the invalidity indicator for the literal load table has been received comprises a means for determining whether a control register is set.

14. The instruction processing circuit of claim 10, wherein the means for determining whether the invalidity indicator for the literal load table has been received comprises a means for detecting a coprocessor instruction invocation.

15. The instruction processing circuit of claim 10, wherein the means for determining whether the invalidity indicator for the literal load table has been received comprises a means for detecting a custom architectural instruction invocation.

16. The instruction processing circuit of claim 10, further comprising:
a means for detecting one of an interrupt, a context switch, and a parallel synchronization event; and
a means for flushing the literal load table responsive to the detecting.

17. A method for identifying invalid literal load values for removal from a literal load table, comprising:
detecting, by a computer processor, an occurrence of a software operation;
determining whether the software operation results in modification of a literal value in a constant table corresponding to an entry in a literal load table; and
responsive to determining that the software operation results in the modification of the literal value, generating an invalidity indicator for the literal load table.

18. The method of claim 17, wherein the software operation comprises one or more of a garbage collection operation and an inline cache address update operation.

19. The method of claim 17, wherein the invalidity indicator comprises an identification of the entry in the literal load table.

20. The method of claim 17, wherein generating the invalidity indicator comprises setting a control register of the computer processor.

21. The method of claim 17, wherein generating the invalidity indicator comprises providing a coprocessor instruction invocation.

22. The method of claim 17, wherein generating the invalidity indicator comprises providing a custom architectural instruction invocation.

23. A non-transitory computer-readable medium having stored thereon computer-executable instructions which, when executed by a processor, cause the processor to:
detect an occurrence of a software operation;
determine whether the software operation results in modification of a literal value in a constant table corresponding to an entry in a literal load table; and
responsive to determining that the software operation results in the modification of the literal value, generate an invalidity indicator for the literal load table.

24. The non-transitory computer-readable medium of claim 23 having stored thereon computer-executable instructions which, when executed by the processor, further cause the processor to detect the occurrence of the software operation by detecting the occurrence of one or more of a garbage collection operation and an inline cache address update operation.

25. The non-transitory computer-readable medium of claim 23 having stored thereon computer-executable instructions which, when executed by the processor, further cause the processor to generate the invalidity indicator comprising an identification of the entry in the literal load table.

26. The non-transitory computer-readable medium of claim 23 having stored thereon computer-executable instructions which, when executed by the processor, further cause the processor to generate the invalidity indicator by setting a control register of the processor.

27. The non-transitory computer-readable medium of claim 23 having stored thereon computer-executable instructions which, when executed by the processor, further cause the processor to generate the invalidity indicator by providing a coprocessor instruction invocation.

28. The non-transitory computer-readable medium of claim 23 having stored thereon computer-executable instructions which, when executed by the processor, further cause the processor to generate the invalidity indicator by providing a custom architectural instruction invocation.
